(19) United States
(12) Patent Application Publication
(10) Pub. No.: US 2010/0069554 A1
(43) Pub. Date: Mar. 18, 2010

(54) CURABLE FLUOROPOLYMER COMPOSITIONS

(75) Inventor: Steven R. Oriani, Landenberg, PA (US)

Correspondence Address: DUPONT PERFORMANCE ELASTOMERS L.L.C., PATENT RECORDS CENTER, 4417 LANCASTER PIKE, BARLEY MILL PLAZA P25, WILMINGTON, DE, 19805, US

(73) Assignee: DuPont Performance Elastomers L.L.C., Wilmington, DE (US)

(21) Appl. No.: 12/556,056

(22) Filed: Sep. 9, 2009

Related U.S. Application Data
(60) Provisional application No. 61/097,891, filed on Sep. 18, 2008.

(51) Int. Cl. C08L 27/12; C08K 3/22

(52) U.S. Cl. 524/433; 524/500; 524/502

(57) ABSTRACT

Polyhydroxy curable fluoropolymer compositions comprise polyhydroxy curable fluoropolymer, a β-fluoroalcohol having the formula R—(CF₂)n-CH₂—OH, wherein R is H, F or CH₃O and n is an integer from 2 to 7, a polyhydroxy curative, acid acceptor and accelerator.

### CROSS-REFERENCE TO RELATED APPLICATIONS

This application claims the benefit of U.S. Provisional Application No. 61/097,891 filed Sep. 18, 2008.

### FIELD OF THE INVENTION

This invention relates to curable compositions comprising polyhydroxy curable fluoropolymer, a β-fluoroalcohol having the formula R—(CF₂)n-CH₂—OH, wherein R is H, F or CH₃O and n is an integer from 2 to 7, a polyhydroxy curative, acid acceptor and accelerator.

### BACKGROUND OF THE INVENTION

Fluoropolymers, including semi-crystalline and amorphous, are well known in the art. Many are homopolymers or copolymers of vinylidene fluoride (VF₂) or tetrafluoroethylene (TFE) with at least one other fluorinated comonomer such as a different fluoroolefin or a perfluoro(alkyl vinyl ether). Other fluoropolymers include copolymers of tetrafluoroethylene with a hydrocarbon olefin such as ethylene or propylene and copolymers of tetrafluoroethylene with a perfluoro(alkyl vinyl ether).

Fluoropolymers may be crosslinked, i.e. cured, in order to improve physical properties. Common curatives include 1) peroxide curing agents wherein free radicals react with chlorine, bromine or iodine cure sites on the polymer chains to form crosslinks, and 2) polyhydroxy curing agents wherein a compound having two or more hydroxy groups reacts at unsaturated sites on polymer chains to form crosslinks. Polyhydroxy cured fluoropolymers are often used in applications such as oil and fuel seals for internal combustion engines, transmission seals, fuel hoses, and industrial oil seals because of their resistance to hydrocarbons and degradation at high temperatures.

The curing of fluoropolymers can be a slow process, adversely impacting process economics. Also polyhydroxy curable fluoroelastomer compounds may have a relatively high Mooney viscosity, making the composition difficult to process via injection molding techniques. Thus, it would be desirable to have polyhydroxy curable fluoropolymer compositions that cure faster and that have lower Mooney viscosity than many current polyhydroxy curable compositions.

### SUMMARY OF THE INVENTION

It has been surprisingly discovered that polyhydroxy curable fluoropolymer compositions that contain certain β-fluoroalcohols cure faster and have lower Mooney viscosity than do comparable compositions absent the β-fluoroalcohols.

An aspect of the present invention is a curable composition comprising:

A) a polyhydroxy curable fluoropolymer, said fluoropolymer containing 0 to 0.01 weight percent, based on total weight of fluoropolymer, of peroxide cure sites selected from the group consisting of chlorine atoms, bromine atoms and iodine atoms;

B) 1 to 50 parts by weight per 100 parts by weight fluoropolymer of a β-fluoroalcohol having the formula R—(CF₂)ₙ—CH₂—OH wherein R is H, F or CH₃O, and n is an integer from 2 to 7;

C) a polyhydroxy curative;

D) an acid acceptor; and

E) an accelerator.

Another aspect of the invention is a method for producing a shaped, cured article comprising the steps:

A) providing a curable composition comprising
i) a polyhydroxy curable fluoropolymer;
ii) 1 to 50 parts by weight per 100 parts by weight fluoropolymer of a β-fluoroalcohol having the formula R—(CF₂)ₙ—CH₂—OH wherein R is H, F or CH₃O, and n is an integer from 2 to 7;
iii) a polyhydroxy curative;
iv) an acid acceptor; and
v) an accelerator;

B) shaping said curable composition to form a curable shaped article; and

C) heating said curable shaped article to a temperature of at least 100° C. to cure said shaped article.

### DETAILED DESCRIPTION OF THE INVENTION

The present invention is directed to polyhydroxy curable fluoropolymer compositions that comprise at least one polyhydroxy curable fluoropolymer, a certain β-fluoroalcohol and a polyhydroxy cure system. The present invention is also directed to a method for making shaped and cured articles from these polyhydroxy curable fluoropolymer compositions.

The fluoropolymer may be amorphous or crystalline. By “crystalline” is meant that the polymers have some degree of crystallinity and are characterized by a detectable melting point measured according to ASTM D 3418, and a melting endotherm of at least 3 J/g. Melt-processible fluoropolymers that are not crystalline according to the preceding definition are amorphous. Amorphous fluoropolymers include fluoroelastomers, which are distinguished by having a glass transition temperature of less than 20° C. The fluoropolymer may be partially fluorinated or perfluorinated.

Fluoropolymers comprise polymerized units of at least one fluoromonomer. Often fluoropolymers comprise copolymerized units of at least one fluoromonomer and a second, different, monomer. By “fluoromonomer” is meant a polymerizable monomer containing at least 35 weight percent (wt. %) fluorine. Such monomers include, but are not limited to fluorine-containing olefins and fluorine-containing vinyl ethers.

Non-elastomeric fluoropolymer can be homopolymers of one fluorinated monomer or copolymers of two or more monomers, at least one of which is fluorinated. The fluorinated monomer is preferably independently selected from the group consisting of tetrafluoroethylene (TFE), hexafluoropropylene (HFP), 3,3,3-trifluoropropene, trifluoroethylene, hexafluoroisobutylene, perfluoroalkyl ethylene, vinyl fluoride (VF), vinylidene fluoride (VF₂), perfluoro-2,2-dimethyl-1,3-dioxole (PDD) and perfluoro-2-methylene-4-methyl-1,3-dioxolane (PMD). Non-fluorinated olefinic comonomers such as ethylene and propylene can be copolymerized with fluorinated monomers.

The fluoropolymer may be a melt-processible non-elastomeric fluoropolymer, provided the structure of the fluoropolymer permits polyhydroxy curing. By melt-processible, it is meant that the polymer can be processed in the molten state (i.e., fabricated from the melt into shaped articles such as films, fibers, and tubes etc. that exhibit sufficient strength and toughness to be useful for their intended purpose). Examples of such melt-processible non-elastomeric fluoropolymers include copolymers of tetrafluoroethylene (TFE) and at least one fluorinated copolymerizable monomer (comonomer) present in the polymer usually in sufficient amount to reduce the melting point of the copolymer substantially below that of polytetrafluoroethylene (PTFE), to a melting temperature no greater than 150° C.

A preferred melt-processible non-elastomeric copolymer that may be employed in the present invention comprises about 70 to 85 wt % vinylidene fluoride (VF₂) units and hexafluoropropylene (HFP). Another preferred melt-processible non-elastomeric co-polymer comprises at least 20 wt. % VF₂, 10-40 wt. % HFP and 10-60 wt. % TFE, provided the composition is crystalline with a melting point of less than about 150° C. Yet another preferred melt-processible non-elastomeric co-polymer comprises TFE and 3,3,3-trifluoropropene, as described in US 2007/0232769 A1 and in pending U.S. application Ser. No. 12/012,069, filed Jan. 31, 2008.

Fluoroelastomers that are suitable for use in this invention are those that are polyhydroxy curable. By “polyhydroxy curable” is meant fluoroelastomers which are known to crosslink with polyhydroxy curatives such as bisphenol AF. Such fluoroelastomers include those having a plurality of carbon-carbon double bonds along the main elastomer polymer chain and also fluoroelastomers which contain sites that may be readily dehydrofluorinated. The latter fluoroelastomers include, but are not limited to those which contain adjacent copolymerized units of vinylidene fluoride (VF₂) and hexafluoropropylene (HFP) as well as fluoroelastomers which contain adjacent copolymerized units of VF₂ (or tetrafluoroethylene) and a fluorinated comonomer having an acidic hydrogen atom such as 2-hydropentafluoropropylene; 1-hydropentafluoropropylene; trifluoroethylene; 2,3,3,3-tetrafluoropropene; or 3,3,3-trifluoropropene. Preferred fluoroelastomers include the copolymers of i) vinylidene fluoride with hexafluoropropylene and, optionally, tetrafluoroethylene (TFE); ii) vinylidene fluoride with a perfluoro(alkyl vinyl ether) such as perfluoro(methyl vinyl ether), 2-hydropentafluoroethylene and optionally, tetrafluoroethylene; iii) tetrafluoroethylene with propylene and 3,3,3-trifluoropropene; iv) tetrafluoroethylene, perfluoro(methyl vinyl ether) and hexafluoro-2-(pentafluorophenoxy)-1-(trifluorovinyloxy) propane, and v) ethylene with tetrafluoroethylene, perfluoro(methyl vinyl ether) and 3,3,3-trifluoropropylene.

Fluoropolymers employed in the curable compositions of this invention are not peroxide curable, i.e. they do not contain sufficient cure sites (e.g. Cl, Br, or I atoms) to render a useful peroxide cured fluoropolymer. This generally means that the fluoropolymer contains 0.01 wt. % or less of these cure sites, preferably 0 wt. %. However, polyhydroxy curable fluoropolymers that are employed in the process of the invention may, optionally, contain Cl, Br or I cure sites, making the fluoropolymer dual curable, i.e. curable by both polyhydroxy and peroxide curatives.

Fluoropolymers are generally prepared by free radical emulsion or suspension polymerization. The polymerizations may be carried out under steady-state conditions. Alternatively, batch, and semi-batch processes may be employed. Preferably, the polyhydroxy curable fluoropolymers employed in this invention have an M_{w} of at least 30,000, most preferably between 50,000 and 500,000.

The β-fluoroalcohol employed in this invention has the formula R—(CF₂)ₙ—CH₂—OH wherein R is H, F or CH₃O, and n is an integer from 2 to 7. Specific examples of such β-fluoroalcohols include, but are not limited to 2,2,3,3-tetrafluoro-1-propanol, 2,2,3,3,3-pentafluoro-1-propanol, 1H,1H,5H octafluoro-1-pentanol, 1H,1H,7H dodecafluoro-1-heptanol, and 3-methoxy-2,2,3,3-tetrafluoro-1-propanol.

In addition to the fluoropolymer and β-fluoroalcohol, curable compositions of this invention contain a polyhydroxy cure system, meaning a polyhydroxy curative, an acid acceptor and a vulcanization (or curing) accelerator.

The curable compositions of the invention contain 0.4 to 4 parts by weight (preferably 1 to 2.5 parts) of polyhydroxy crosslinking agent (or a derivative thereof) per 100 parts by weight fluoropolymer. Typical polyhydroxy cross-linking agents include di-, tri-, and tetrahydroxybenzenes, naphthalenes, and anthracenes, and bisphenols of the formula

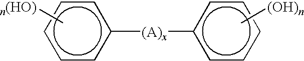

where A is a difunctional aliphatic, cycloaliphatic, or aromatic radical of 1-13 carbon atoms, or a thio, oxy, carbonyl, sulfinyl, or sulfonyl radical; A may optionally be substituted with at least one chlorine or fluorine atom; x is 0 or 1; n is 1 or 2; and any aromatic ring of the polyhydroxylic compound may optionally be substituted with at least one chlorine or fluorine atom, an amino group, a —CHO group, or a carboxyl or acyl radical. Preferred polyhydroxy compounds include hexafluoroisopropylidene-bis(4-hydroxy-benzene) (i.e. bisphenol AF or BPAF); 4,4′-isopropylidene diphenol (i.e. bisphenol A); 4,4′-dihydroxydiphenyl sulfone; and diaminobisphenol AF. Referring to the bisphenol formula shown above, when A is alkylene, it can be for example methylene, ethylene, chloroethylene, fluoroethylene, difluoroethylene, propylidene, isopropylidene, tributylidene, heptachlorobutylidene, heptafluorobutylidene, pentylidene, hexylidene, and 1,1-cyclohexylidene. When A is a cycloalkylene radical, it can be for example 1,4-cyclohexylene, 2-chloro-1,4-cyclohexylene, cyclopentylene, or 2-fluoro-1,4-cyclohexylene. Further, A can be an arylene radical such as m-phenylene, p-phenylene, o-phenylene, methylphenylene, dimethylphenylene, 1,4-naphthylene, 3-fluoro-1,4-naphthylene, and 2,6-naphthylene. Polyhydroxyphenols of the formula

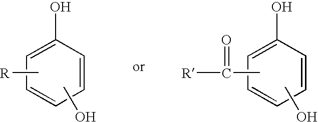

where R is H or an alkyl group having 1-4 carbon atoms or an aryl group containing 6-10 carbon atoms and R′ is an alkyl group containing 1-4 carbon atoms also act as effective crosslinking agents. Examples of such compounds include hydroquinone, catechol, resorcinol, 2-methylresorcinol, 5-methyl-resorcinol, 2-methylhydroquinone, 2,5-dimethylhydroquinone, 2-t-butyl-hydroquinone; and such compounds as 1,5-dihydroxynaphthalene and 2,6-dihydroxynaphthalene.

Additional polyhydroxy curing agents include alkali metal salts of bisphenol anions, quaternary ammonium salts of bisphenol anions, tertiary sulfonium salts of bisphenol anions and quaternary phosphonium salts of bisphenol anions. For example, the salts of bisphenol A and bisphenol AF. Specific examples include the disodium salt of bisphenol AF, the dipotassium salt of bisphenol AF, the monosodium monopotassium salt of bisphenol AF and the benzyltriphenylphosphonium salt of bisphenol AF.

Quaternary ammonium and phosphonium salts of bisphenol anions are discussed in U.S. Pat. Nos. 4,957,975 and 5,648,429. Bisphenol AF salts (1:1 molar ratio) with quaternary ammonium ions of the formula R₁R₂R₃R₄N⁺, wherein R₁-R₄ are C₁-C₈ alkyl groups and at least three of R₁-R₄ are C₃ or C₄ alkyl groups are preferred. Specific examples of these preferred compositions include the 1:1 molar ratio salts of tetrapropyl ammonium-, methyltributylammonium- and tetrabutylammonium bisphenol AF. Such salts may be made by a variety of methods. For instance a methanolic solution of bisphenol AF may be mixed with a methanolic solution of a quaternary ammonium salt, the pH is then raised with sodium methoxide, causing an inorganic sodium salt to precipitate. After filtration, the tetraalkylammonium/BPAF salt may be isolated from solution by evaporation of the methanol. Alternatively, a methanolic solution of tetraalkylammonium hydroxide may be employed in place of the solution of quaternary ammonium salt, thus eliminating the precipitation of an inorganic salt and the need for its removal prior to evaporation of the solution.

In addition, derivatized polyhydroxy compounds such as mono- or diesters, and trimethylsilyl ethers are useful crosslinking agents. Examples of such compositions include, but are not limited to resorcinol monobenzoate, and the mono or diacetates of bisphenol AF, sulfonyl diphenol, and hydroquinone.

The curable compositions of the invention also contain between 1 to 60 parts by weight (preferably 4 to 40 parts) of an acid acceptor per 100 parts fluoroelastomer. The acid acceptor is typically a strong organic base such as Proton Sponge® (available from Aldrich) or an oxirane, or an inorganic base such as a metal oxide, metal hydroxide, or a mixture of two or more of the latter. Metal oxides or hydroxides which are useful acid acceptors include calcium hydroxide, magnesium oxide, lead oxide, zinc oxide and calcium oxide. Calcium hydroxide and magnesium oxide are preferred when low levels of β-fluoroalcohol are used (less than about 10 parts by weight per 100 parts by weight fluoropolymer (phr)), whereas calcium oxide and magnesium oxide are preferred when greater than about 10 phr β-fluoroalcohol is used.

Vulcanization accelerators (also referred to as cure accelerators) which may be used in the curable compositions of the invention include tertiary sulfonium salts such as [(C₆H₅)₂S⁺(C₆H₁₃)][Cl]⁻, and [(C₆H₁₃)₂S(C₆H₅)]⁺[CH₃CO₂]⁻ and quaternary ammonium, phosphonium, arsonium, and stibonium salts of the formula R₅R₆R₇R₈Y⁺X⁻, where Y is phosphorus, nitrogen, arsenic, or antimony; R₅, R₆, R₇, and R₈ are individually C₁-C₂₀ alkyl, aryl, aralkyl, alkenyl, and the chlorine, fluorine, bromine, cyano, —OR, and —COOR substituted analogs thereof, with R being C₁-C₂₀ alkyl, aryl, aralkyl, alkenyl, and where X is halide, hydroxide, sulfate, sulfite, carbonate, pentachlorothiophenolate, tetrafluoroborate, hexafluorosilicate, hexafluorophosphate, dimethyl phosphate, and C₁-C₂₀ alkyl, aryl, aralkyl, and alkenyl carboxylates and dicarboxylates. Particularly preferred are benzyltri-phenylphosphonium chloride, benzyltriphenylphosphonium bromide, tetrabutylammonium hydrogen sulfate, tetrabutylammonium hydroxide, tetrapropylammonium hydroxide, tetrabutylammonium bromide, tributylallylphosphonium chloride, tributyl-2-methoxypropylphosphonium chloride, 1,8-diazabicyclo[5.4.0]undec-7-ene, and benzyldiphenyl(dimethylamino) phosphonium chloride. Other useful accelerators include methyltrioctylammonium chloride, methyltributylammonium chloride, tetrapropylammonium chloride, benzyltrioctylphosphonium bromide, benzyltrioctylphosphonium chloride, methyltrioctylphosphonium acetate, tetraoctylphosphonium bromide, methyltriphenylarsonium tetrafluoroborate, tetraphenylstibonium bromide, 4-chlorobenzyltriphenyl phosphonium chloride, 8-benzyl-1,8-diazabicyclo(5.4.0)-7-undecenonium chloride, diphenylmethyltriphenylphosphonium chloride, allyltriphenyl-phosphonium chloride, tetrabutylphosphonium bromide, m-trifluoromethyl-benzyltrioctylphosphonium chloride, and other quaternary compounds disclosed in U.S. Pat. Nos. 5,591,804; 4,912,171; 4,882,390; 4,259,463; 4,250,278 and 3,876,654. The amount of accelerator used is between 0.05 and 2 parts by weight per hundred parts by weight fluoroelastomer. Preferably, 0.1 to 1.0 parts accelerator per hundred parts fluoroelastomer is used.

It is believed that, during curing, β-fluoroalcohol becomes grafted to the fluoropolymer at sites where polyhydroxy curative might otherwise react. The amount of acid acceptor and accelerator in the compound affects the completeness of the β-fluoroalcohol grafting during the curing of the composition, such that increased levels of acid acceptor and/or accelerator increase the amount of the β-fluoroalcohol that becomes grafted to the fluoropolymer. A high level of β-fluoroalcohol grafting is desirable to minimize weight loss and shrinkage when a molded and cured article is exposed to elevated temperatures that can volatilize ungrafted β-fluoroalcohol. Without wishing to be bound by any mechanism, it is theorized that the grafting reaction is initiated when the β-fluoroalcohol becomes ionized by losing a proton from the hydroxyl group, creating a nucleophile. It is therefore within the scope of this invention to use β-fluoroalcohols that have been ionized to form salts in full or in part prior to addition to the fluoropolymer, e.g., β-fluoroalcohols in the form of ammonium, phosphonium, calcium, potassium, zinc, or magnesium salts. Within the teachings of this invention, one of ordinary skill in the art can manipulate these components to achieve the technical aims required for a particular application.

Grafting of the β-fluoroalcohol to the fluoropolymer takes place when carbon-carbon double bonds form on the fluoropolymer chains while the curable composition is being heated during curing. An exception is grafting of a perfluoroelastomer through the reactive sites on a perfluorophenoxy propyl vinyl ether, in which double bond formation does not take place.

Optionally, additives generally used in fluoropolymer and rubber processing may be present in the curable composition of the invention. Such additives include colorants, process aids, and fillers such as carbon black, fluoropolymer micropowders and mineral powders.

Curable compositions of the invention may be made by mixing the ingredients in mixers commonly employed in the fluoropolymer industry, e.g. extruders, rubber mills, Banbury® mixers, etc. In a preferred process, the β-fluoroalcohol is added last to the composition.

Cured, shaped articles may be made by shaping (e.g. in a die or in a mold) the curable composition of the invention and curing the shaped article. Shaping and curing may be performed simultaneously or in sequential steps. Curing generally takes place at a temperature of at least 100° C., preferably between 150° and 200° C., for 2 to 20 minutes. Typically curing takes place under compression. Post curing, under atmospheric pressure, at a temperature between 200° and 270° C. may be performed for 30 minutes to 24 hours in order to further crosslink the fluoropolymer and drive off any unreacted β-fluoroalcohol.

Fluoropolymers made from the curable compositions of this invention have utility in end uses such as injection, compression, or transfer molded seals, o-rings, and gaskets, extruded tubing and hoses, extruded wire coatings, coatings applied by solvent or flame spray processes, and others.

The invention is now illustrated by the following embodiments in which all parts are by weight unless otherwise indicated.

### Examples

### Test Methods

Mooney viscosity ASTM D1646, ML 1+10, at specified temperature
Capillary viscosity Measured on a Rosand RH2000 capillary rheometer fitted with a 1 mm×10 mm die with a flat entry. Test temperature of 80° C. and shear rate of 10 sec⁻¹. Data are uncorrected for entry and exit effects.
MDR cure MDR 2000 from Alpha Technologies operating at 0.5° arc. Test conditions of 177° C. for 10 minutes unless otherwise noted. T50 and T90 refer to the time to 50% and 90%, respectively, of the maximum torque.
Compression set ASTM D395B, 25% compression, using AS568A-214 o-rings molded at 177° C. for 10 minutes unless otherwise noted. Post cure and test conditions as specified. Data reported are an average of 3 specimens.
Tensile properties ASTM D412, die C. Samples cut from 1.5 mm thick plaques compression molded at 177° C. for 10 minutes unless otherwise noted, post cured as specified. Data reported are an average of 3 specimens.
Shore A hardness ASTM D2240, 1 sec.
Shrinkage Measured on 1.5 mm thick plaques compression molded at 177° C. for 10 minutes, post cured as specified. The mold contains two small dimples, 141.28 mm apart, which generate tiny molded-in points on the surface of the plaque. The distance between these points was measured using micrometers to the nearest 0.13 micrometer. All measurements (mold and plaques) are taken at room temperature after post curing the plaque as specified. Percent shrink is calculated by: (141.28-measured distance in mm)/1.4128.
Weight loss Measured on 1.5×76.2×156.4 mm compression molded plaques, molded as specified in the examples. After molding, the plaques were cooled at room temperature for 10 minutes, then weighed to the nearest 0.1 mg. The plaques were then post cured 4 hours at 200° C., cooled, and re-weighed. The percent weight loss is calculated by: 100×(initial−final weight)/initial weight.
   The following ingredients were used in the examples.
Viton® A100 Fluoroelastomer with a nominal monomer composition of 60 weight % vinylidene fluoride, 40 weight % hexafluoropropylene. The Mooney viscosity at 121° C. (ML 1+10) was 10.
Viton® B600 Fluoroelastomer with a nominal monomer composition of 45 weight % vinylidene fluoride, 31 weight % hexafluoropropylene, and 24% tetrafluoroethylene. The Mooney viscosity at 121° C. (ML 1+10) was 60.
Viton® GAL200s Fluoroelastomer with a nominal monomer composition of 62.8 wt. % vinylidene fluoride, 27.4 wt. % hexafluoropropylene, 9.5 wt. % tetrafluoroethylene, and 0.3 wt. % iodine. The Mooney viscosity at 121° C. (ML 1+10) was 30.
BTPPC Benzyltriphenylphosphonium chloride
Luperox® 101 2,5-dimethyl-2,5-di(t-butylperoxy) hexane, supplied as a 45% by weight active blend with calcium carbonate and silica. Available from Sigma Aldrich.
TAIC Triallylisocyanurate, available from Mitsubishi International Corp.
Zinc Oxide Kadox® 911, available from Zinc Corporation of America.
Calcium hydroxide HP-XL, available from Hallstar Co.
Elastomag® 170 Magnesium oxide available from Akrochem Corp.
Calcium oxide Available from Sigma Aldrich as 24,856-8
VC50 curative Salt of benzyltriphenylphosphonium chloride reacted with bisphenol AF, available from DuPont Performance Elastomers L.L.C.
MT black Medium thermal N990 carbon black available from Cabot Corp.
FA-1 2,2,3,3-tetrafluoro-1-propanol, 99.9%, available from Synquest Laboratories, Inc.
FA-2 2,2,3,3,3-pentafluoro-1-propanol, available from Sigma Aldrich
FA-3 1H,1H,5H octafluoro-1-pentanol, 99.5% available from Synquest Laboratories, Inc.
FA-4 1H,1H,7H dodecafluoro-1-heptanol, available from Synquest Laboratories, Inc.
FA-5 3-methoxy-2,2,3,3-tetrafluoro-1-propanol
HA-1 1-propanol, available from Sigma Aldrich
HA-2 1-pentanol, available from Sigma Aldrich

FA-5 was prepared by the following procedure.

### Step I. Preparation of Methyl 3-Methoxy-2,2,3,3-Tetrafluoropropionate [CH3O—CF2CF2-COOMe]

In a 1-liter reactor was charged dimethyl carbonate (540 grams, 6 moles) and sodium methoxide (63 grams, 1.17 moles). The reactor was sealed, cooled and evacuated. Tetrafluoroethylene (TFE) was then transferred into the reactor and the pressure maintained at 30 psig (207 kPa). The reactor was heated at 45° C. for 5 hours, and about 150 grams of TFE was consumed. The reactor was cooled, and the pot product mixture was neutralized and acidified with concentrated sulfuric acid to pH 1. The salt residue was filtered and discarded. The filtered product was washed twice with water. A distillation gave the desired product as a clear, colorless liquid. Bp. 63° C./35 mmHg (4.7 kPa), yield: 135 grams (61%).

### Step II. Preparation of 3-Methoxy-2,2,3,3-Tetrafluoro-1-Propanol [CH3O—CF2CF2-CH2OH]

Lithium aluminum hydride (45.6 grams, 1.20 moles) was suspended in anhydrous ether (1.0 liter) at 10° C. Then methyl 3-methoxy-2,2,3,3-tetrafluoropropionate (275 grams, 1.50 moles) was added slowly to the suspension. The pot temperature was maintained at less than 15° C. with external cooling. After the addition was completed, the reaction mixture was warmed to ambient temperature and was stirred for an additional 2 hours. The product mixture was poured into a 6N HCl aqueous solution, and the organic layer was separated, dried over magnesium sulfate, then distilled to afford the desired product as a clear, colorless liquid. Bp. 142-144° C., yield 130 grams (53.5%). ¹H-NMR (CDCl₃, 400 MHz): 3.96 (t, J=14.4 Hz, 2H), 3.68 (s, 3H), 2.60 (s, br, 1H); ¹⁹F-NMR (CDCl₃, 376.89 MHZ): −92.9 (s, 2F), −126.7 (tt, J=4.0 Hz, 14.4 Hz, 2F). The purity, as determined by gas chromatography and ¹⁹F-NMR, was better than 99%

All compounds employed in the examples were mixed on a two roll mill. Where used, the β-fluoroalcohol was added last, so that the dispersion of bases and VC50 (salt of polyhydroxy curative and accelerator) was not affected by the low compound viscosity resulting from the β-fluoroalcohol addition.

### Example 1

Curable compositions of the invention (S1 and S2) that contained a β-fluoroalcohol, and comparative compositions (CS1 and CS2) that contained either no alcohol (CS1) or a hydrocarbon alcohol (CS2), rather than a β-fluoroalcohol, were made as described above. Formulations are shown in Table I. Cure rate, compression set of O-rings and physical properties of plaques were measured according to the Test Methods. Compression set and physical properties were measured on articles that had been press cured at 160° C. (177° C. for CS1) for 10 minutes, followed by an oven post cure for 4 hours at 200° C. Results are also included in Table I.

TABLE I

| Formulation, | | | | |
|---|---|---|---|---|
| phr¹ | CS1 | S1 | S2 | CS2 |
| Viton ® A100 | 100 | 100 | 100 | 100 |
| VC50 Curative | 2 | 2 | 2 | 2 |
| Ca(OH)₂ HP-XL | 6 | 6 | 6 | 6 |
| Elastomag ® 170 | 3 | 3 | 3 | 3 |
| MT Black | 10 | 10 | 10 | 10 |
| FA-1 | 0 | 20 | 30 | 0 |
| HA-1 | 0 | 0 | 0 | 20 |
| Mooney viscosity, | 16.6 | 5.2 | 2.4 | — |
| 121° C. | | | | |
| Capillary viscosity | 52790 | 11310 | 6250 | 30730 |
| (Pa-s), 80° C. | | | | |
| Weight loss (%), | 0.78 | 3.44 | 5.61 | 4.12 |
| 4 hours, 200° C. | | | | |
| Shrinkage (%), | 3.3 | 4.8 | 5.7 | 6.2 |
| post cured 4 | | | | |
| hours, 200° C. | | | | |
| Curing | 12 | 6 minutes | 6 minutes | 6 minutes |
| characteristics, | minutes | | | |
| 160° C. | | | | |
| Minimum torque | 0.18 | 0.03 | 0.01 | 0.07 |
| (dN-m) | | | | |
| Maximum torque | 8.4 | 7.5 | 6.75 | 6.8 |
| (dN-m) | | | | |
| T50, minutes | 5.4 | 1.1 | 0.9 | 0.8 |
| T90, minutes | 8.2 | 1.3 | 1.1 | 1.0 |
| Physical | | | | |
| properties | | | | |
| Compression set | 10 | 10 | 14 | 13 |
| (%), 70 hours, | | | | |
| 150° C. | | | | |
| Hardness, Shore A | 56 | 59 | 57 | 55 |
| 50% Modulus | 1.0 | 1.2 | 1.0 | 1.1 |
| (MPa) | | | | |
| 100% Modulus | 1.7 | 2.0 | 1.8 | 1.7 |
| (MPa) | | | | |
| Tensile @ break | 7.4 | 8.8 | 8.5 | 8.8 |
| (MPa) | | | | |
| Elongation @ | 260 | 270 | 270 | 300 |
| break (%) | | | | |

¹parts by weight per 100 parts fluoroelastomer (rubber)

Compositions of the invention S1 and S2 show that inclusion of 20 to 30 phr of a β-fluoroalcohol (FA-1) reduces compound Mooney viscosity at 121° C. (ML 1+10) by a factor of approximately three to five compared to control compound CS1, containing no β-fluoroalcohol or hydrocarbon alcohol. At 80° C., the capillary viscometer data show that both S1 and S2 provide lower viscosity than CS1 by even larger factors of about 5 to 8, respectively. In addition, S1 and S2 cured in a much shorter time than CS1, with t90 dropping over 6-fold as a result of the FA-1 addition. The lower viscosity and faster cure of the compositions of the invention are an advantage in economic production of fluoroelastomer parts. At the same time, S1 maintained compression set resistance equal to CS1, while S2 (with 30 phr FA-1) yielded only slightly higher permanent set than CS1. Hardness, tensile modulus, and tensile elongation at break remained essentially unchanged as a result of FA-1 addition, while tensile strength improved.

The 20 phr of hydrocarbon alcohol (HA-1) used in CS2 produced greater weight loss and shrinkage upon heat aging than the same amount of β-fluorinated alcohol in S1. These changes are undesirable, because fluoroelastomers are commonly chosen for high temperature end use applications. At the same time, CS2 had a nearly three-fold higher viscosity than S1, showing that the hydrocarbon alcohol HA-1 was a less effective viscosity depressant than the β-fluorinated alcohol FA-1. The addition of 20 phr HA-1 did yield a slightly faster cure than 20 phr of FA-1 (CS2 compared to S1), but compression set resistance of CS2 was slightly inferior to S1.

### Example 2

Curable compositions of the invention (S3-S7) that contained a β-fluoroalcohol, and comparative compositions (CS3 and CS4) that contained either no alcohol (CS3) or a hydrocarbon alcohol (CS4), rather than a β-fluoroalcohol, were made as described above. Formulations are shown in Table II. Cure rate and physical properties of plaques were measured according to the Test Methods. Physical properties were measured on plaques that had been press cured at 177° C. for 10 minutes, followed by an oven post cure for 30 minutes (4 hours for S7) at 200° C. Comparative samples CS3 and CS4 did not press cure well, so they were not post cured and physical properties were not measured. Results are also included in Table II.

TABLE II

| Formulation, | | | | | | | |
|---|---|---|---|---|---|---|---|
| phr | CS3 | S3 | S4 | S5 | S6 | S7 | CS4 |
| Viton ® A-100 | 100 | 100 | 100 | 100 | 100 | 100 | 100 |
| VC50 | 2 | 2 | 2 | 2 | 2 | 2 | 2 |
| Elastomag ® | 30 | 30 | 30 | 30 | 30 | 30 | 30 |
| 170 | | | | | | | |
| FA-1 | 0 | 25 | 0 | 0 | 0 | 0 | 0 |
| FA-2 | 0 | 0 | 25 | 0 | 0 | 0 | 0 |
| FA-3 | 0 | 0 | 0 | 25 | 0 | 0 | 0 |
| FA-4 | 0 | 0 | 0 | 0 | 25 | 0 | 0 |
| FA-5 | 0 | 0 | 0 | 0 | 0 | 25 | 0 |
| HA-2 | 0 | 0 | 0 | 0 | 0 | 0 | 25 |
| Capillary | 49860 | 13175 | — | 14260 | 15600 | 14465 | 26555 |
| viscosity (Pa- | | | | | | | |
| s), 80° C. | | | | | | | |
| Weight loss | — | — | 2.48 | 2.26 | 3.29 | 6.93 | 4.95 |
| (%), 4 hours, | | | | | | | |
| 200° | | | | | | | |
| Shrinkage (%), | — | 3.3 | 3.8 | 3.5 | — | — | — |
| post cure 4 | | | | | | | |
| hours, 200° C. | | | | | | | |
| Cure | | | | | | | |
| Characteristics | | | | | | | |
| Minimum | 0.37 | 0.05 | 0.15 | 0.06 | 0.05 | 0.05 | 0.18 |
| torque (dN-m) | | | | | | | |
| Maximum | 0.48 | 7.97 | 4.47 | 6.98 | 3.91 | 4.5 | 1.27 |
| torque (dN-m) | | | | | | | |
| T50 (minutes) | — | 1.07 | 1.18 | 1.05 | 1.52 | 1.47 | — |
| T90 (minutes) | — | 3.27 | 5.77 | 3.02 | 5.52 | 5.68 | — |
| Physical | | | | | | | |
| properties | | | | | | | |
| Hardness, | — | 63 | 68 | 62 | 55 | 64 | — |
| Shore A | | | | | | | |
| 50% Modulus | — | 1.4 | 1.9 | 1.5 | 1.0 | 1.5 | — |
| (MPa) | | | | | | | |
| 100% Modulus | — | 2.1 | 3.1 | 2.6 | 1.6 | 3.4 | — |
| (MPa) | | | | | | | |
| Tensile at | — | 8.1 | 10.1 | 7.4 | 7.3 | 7.0 | — |
| break (MPa) | | | | | | | |
| Elongation at | — | 330 | 295 | 235 | 300 | 165 | — |
| break (%) | | | | | | | |

In this example, a series of curable compositions differing only in the presence and type of alcohol in the compound were prepared and the properties measured. Comparative sample CS3 contained no alcohol, and yielded essentially no cure response, with a maximum MDR torque of only 0.48 dN-m. Comparative sample CS4, containing hydrocarbon alcohol HA-1, cured poorly with an MDR maximum torque of 1.27 dN-m. Both of these comparative samples produced blistered plaques that were unsuitable for tensile testing. Samples of the invention S3 through S7 contained β-fluoroalcohols according to the teachings of this invention, and yielded MDR maximum torques of 3.91 to 7.97 dN-m. Even so, all of the inventive compositions provided about two to four times lower viscosity than either CS3 or CS4, resulting in easier processing for the compositions of the invention. All of the inventive compositions could be molded into plaques, and yielded good tensile properties. Composition CS4 could be molded well enough to measure weight loss after a 4 hour, 200° C. post cure, and was found to produce greater weight loss than S4, S5, and S6. S3 was not tested for weight loss, and S8 gave more weight loss than CS4. Shrinkage, after molding 10 minutes at 177° C. followed by a 4 hour, 200° C. post cure, was measured on S3, S4, and S5. These all gave low shrinkage, comparable to CS1 made without β-fluoroalcohol.

### Example 3

Curable compositions of the invention (S8 and S9) that contained a β-fluoroalcohol, and comparative composition (CS5) that did not contain a β-fluoroalcohol were made as described above. Formulations are shown in Table III. Cure rate and physical properties of plaques were measured according to the Test Methods. Compression set (of O-rings) and physical properties (of plaques) that had been press cured at 177° C. for 10 minutes, followed by an oven post cure for 4 hours at 200° C. are included in Table III.

TABLE III

| Formulation, phr | CS5 | S8 | S9 |
|---|---|---|---|
| Viton ® A100 | 100 | 100 | 100 |
| VC50 | 2.75 | 2.75 | 2.75 |
| Calcium oxide | 15 | 15 | 0 |
| Elastomag ® 170 | 15 | 15 | 30 |
| FA-3 | 0 | 30 | 30 |
| Capillary viscosity | 48850 | 11220 | 10560 |
| (Pa-s), 80° C. | | | |
| Weight loss (%), 4 | 0.24 | 1.42 | 2.45 |
| hours, 200° C. | | | |
| Shrinkage (%), 4 | 2.7 | 3.4 | 4.5 |
| hours, 200° C. | | | |
| Cure characteristics | | | |
| Minimum Torque | 0.17 | 0.02 | 0.03 |
| (dN-m) | | | |
| Maximum torque | 9.3 | 14.3 | 12.0 |
| (dN-m) | | | |
| T50 (minutes) | 1.45 | 0.8 | 0.75 |
| T90 (minutes) | 2.65 | 1.8 | 1.05 |
| Physical properties | | | |
| Compression set | 17 | 11 | 17 |
| (%), 150° C., 70 hours | | | |
| Hardness, Shore A | 63 | 66 | 72 |
| 50% Modulus (MPa) | 1.3 | 1.8 | 2.2 |
| 100% Modulus | 2.4 | 3.9 | 4.6 |
| (MPa) | | | |
| Tensile at break | 9.9 | 7.4 | 9.0 |
| (MPa) | | | |
| Elongation at break | 265 | 165 | 180 |
| (%) | | | |

This example demonstrates that certain bases (e.g. metal oxides) may be selected to optimize properties of a curable composition comprising a β-fluoroalcohol. Dehydrating bases such as calcium oxide are particularly favored. CS5 and S8 use a mixture of 15 phr each of calcium oxide and magnesium oxide as the base package, and S8 contains 30 phr of FA-3, whereas CS5 does not. S9 uses 30 phr of magnesium oxide and no calcium oxide, but is otherwise identical to S8. Both of the compositions of the invention (S8 and S9) provided over four times lower viscosity than the comparative composition (CS5), and both S8 and S9 cured faster than CS5. However, composition S8 showed certain advantages compared to S9. S8 cured to a higher MDR maximum torque than S9, yielded lower weight loss and shrinkage after four hours at 200° C., and provided better compression set resistance. Given that S8 contains 18.4% by weight of FA-3, the amount of ungrafted FA-3 in S8 after a 10 minute, 177° C. press cure can be estimated using the weight loss figures for S8 and comparative example CS5:

100×(1.42−0.24)/18.4=estimated 6.4% of the initial quantity of FA-3 in curable composition S8 remained ungrafted after press cure.

In addition, the shrinkage of S8 was only slightly greater than that of CS5 after a 4 hour, 200° C. post cure. Both the weight loss and shrinkage therefore indicate that the β-fluoroalcohol is substantially non-fugitive after curing a composition formulated according to these teachings.

### Example 4

A curable composition of the invention (S10) and a comparative composition (CS6) were made as described above. Formulations are shown in Table IV. The plaques and o-rings were press cured at 177° C. for 10 minutes, then post cured at either 200° C. for 4 hours, or at 232° C. for 16 hours. Cure characteristics of the compositions and physical properties of the post cured parts are also shown in Table IV.

Comparative composition CS6 contained no β-fluoroalcohol, and employed a conventional combination of calcium hydroxide and magnesium oxide as acid acceptor. Composition S10 of the invention contained 20 phr of FA-3, and employed 5 phr each of calcium oxide and magnesium oxide. Due to the cure accelerating effect of the β-fluoroalcohol, CS6 and S10 cured at similar rates, even though S10 lacked calcium hydroxide. S10, however, had a Mooney viscosity at 121° C. that is less than half that of CS6, which confers a large advantage in processability. Even so, S10 provided compression resistance similar to CS6, and a shrinkage that was only slightly greater than that of CS6. Tensile strength and elongation were lower in S10 than in CS6, but still adequate for many end use applications.

TABLE IV

| Formulation, phr | CS6 | S10 |
|---|---|---|
| Viton ® B600 | 100 | 100 |
| VC50 | 2.5 | 2.5 |
| Calcium hydroxide | 6 | 0 |
| HP-XL | | |
| Calcium oxide | 0 | 5 |
| Elastomag ® 170 | 3 | 5 |
| FA-3 | 0 | 20 |
| MT Black | 30 | 30 |
| Mooney viscosity, | 108 | 43 |
| 121° C. | | |
| Weight loss (%), 4 | 0.77 | 1.83 |
| hours, 200° C. | | |
| Weight loss (%), 16 | 1.15 | 2.68 |
| hours, 232° C. | | |
| Shrinkage (%), 4 | 3.1 | 3.5 |
| hours, 200° C. | | |
| Shrinkage (%), 16 | 3.3 | 4.3 |
| hours, 232° C. | | |
| Cure characteristics | | |
| Minimum Torque | 1.87 | 0.53 |
| (dN-m) | | |
| Maximum torque | 27.5 | 29.46 |
| (dN-m) | | |
| T50 (minutes) | 3.75 | 4.0 |
| T90 (minutes) | 5.27 | 5.82 |
| Physical properties | | |
| Post cured 4 hours at | | |
| 200° C. | | |
| Compression set | 22 | 24 |
| (%), 200° C., 70 hours | | |
| Hardness, Shore A | 72 | 77 |
| 50% Modulus (MPa) | 2.4 | 3.0 |
| 100% Modulus | 4.8 | 5.2 |
| (MPa) | | |
| Tensile at break | 10.8 | 8.4 |
| (MPa) | | |
| Elongation at break | 240 | 180 |
| (%) | | |
| Physical properties | | |
| Post cured 16 hours | | |
| at 232° C. | | |
| Compression set | 19 | 18 |
| (%), 200° C., 70 hours | | |
| Hardness, Shore A | 74 | 79 |
| 50% Modulus (MPa) | 2.6 | 3.2 |
| 100% Modulus | 4.8 | 5.8 |
| (MPa) | | |
| Tensile at break | 12.1 | 8.7 |
| (MPa) | | |
| Elongation at break | 230 | 155 |
| (%) | | |

### Example 5

The following example illustrates the benefit of the present invention (wherein grafting of the β-fluoroalcohol to the fluoroelastomer takes place during curing) in providing low viscosity curable compositions compared to similar curable compositions wherein the fluoroalcohol is grafted to the fluoroelastomer prior to forming the curable composition.

A peroxide curable fluoroelastomer, Viton® GAL200s, was compounded with an accelerator, acid acceptor, β-fluoroalcohol, and carbon black to produce comparative composition CS7 (formulation shown in Table V). Note that although the GAL200s polymer may be either polyhydroxy or peroxide crosslinked, comparative composition CS7 is not a curable composition because it contains neither curative. Grafting of a portion of the β-fluoroalcohol to the fluoroelastomer occurred when CS7 was placed in an oven for 1 hour at 100° C. The weight loss of CS7 during this heat treatment was 2.7%. A portion of grafted CS7 was compounded with zinc oxide, triallyl isocyanurate (TAIC), and peroxide to create a peroxide curable comparative composition CS8. Another portion of grafted CS7 was compounded with bisphenol AF to produce polyhydroxy curable comparative composition CS9.

Table V also displays two inventive compositions, S11 and S12, (made by blending together all of the ingredients at room temperature where grafting of the fluoroalcohol to the fluoroelastomer did not occur). Both S11 and S12 contained the same amount of β-fluoroalcohol, accelerator and carbon black as did CS7. For purposes of comparison, S11 maintained the same acid acceptor as CS7, whereas S12 employed a more preferable combination of acid acceptors as taught in the previous examples.

Table V shows that the viscosities of the comparative curable compositions (CS8 and CS9) were substantially greater than the viscosities of the curable compositions (S11 and S12) of the invention wherein the β-fluoroalcohol was not grafted to the fluoroelastomer. All four of the compositions cured vigorously, but composition S12 yielded markedly lower weight loss and shrinkage than did the other compositions. Noting that the full weight loss involved in making a molded, post cured article from CS8 and CS9 must account for the weight loss of CS7 during the oven treatment, the full weight losses of CS8 and CS9 were approximately 5.6% and 5.0%, respectively. Thus, CS8 and CS9 did not provide a significant reduction in weight loss even when compared to composition S11 (to compare compositions with the same base content), while compared to S12, the total weight losses of CS8 and CS9 were several times greater.

TABLE V

| Formulation, phr | CS7 | S11 | S12 | CS8 | CS9 |
|---|---|---|---|---|---|
| Viton ® GAL200s | 100 | 100 | 100 | | |
| CS7 | | | | 176.1 | 176.1 |
| Bisphenol AF | | 2.0 | 2.0 | | 2.0 |
| BTPPC | 0.6 | 0.6 | 0.6 | | |
| Calcium hydroxide | 6 | 6 | | | |
| HP-XL | | | | | |
| Elastomag ® 170 | 3 | 3 | 15 | | |
| Calcium oxide | | | 15 | | |
| FA-3 | 36.5 | 36.5 | 36.5 | | |
| MT Black | 30 | 30 | 30 | | |
| Zinc Oxide | | | | 3 | |
| TAIC | | | | 3 | |
| Luperox ® 101 (45%) | | | | 3 | |
| Total phr | 176.1 | 178.1 | 199.1 | 185.1 | 178.1 |
| Weight loss, 1 hour | 2.7 | | | | |
| at 100° C. | | | | | |
| Compound viscosity | | | | | |
| and cure | | | | | |
| characteristics | | | | | |
| Capillary viscosity | | 6690 | 9030 | 16050 | 21720 |
| (Pa-s), 80° C. | | | | | |
| Minimum Torque | | 0.1 | 0.1 | 0.15 | 0.28 |
| (dN-m) | | | | | |
| Maximum torque | | 12.4 | 34.6 | 12.1 | 10.3 |
| (dN-m) | | | | | |
| T50 (minutes) | | 0.48 | 0.78 | 0.72 | 2.62 |
| T90 (minutes) | | 0.63 | 6.6 | 1.15 | 7.62 |
| Properties of plaques | | | | | |
| molded at 177° C., 10 | | | | | |
| minutes | | | | | |
| Weight loss (%), 4 | | 5.9 | 1.6 | 2.9 | 2.3 |
| hours, 200° C. | | | | | |
| Shrinkage (%), 4 | | 5.3 | 3.8 | 4.3 | 4.1 |
| hours, 200° C. | | | | | |

What is claimed is:

1. A curable composition comprising:
A) a polyhydroxy curable fluoropolymer, said fluoropolymer containing 0 to 0.01 weight percent, based on total weight of fluoropolymer, of peroxide cure sites selected from the group consisting of chlorine atoms, bromine atoms and iodine atoms;
B) 1 to 50 parts by weight per 100 parts by weight fluoropolymer of a β-fluoroalcohol having the formula R—(CF₂)ₙ—CH₂—OH wherein R is H, F or CH₃O, and n is an integer from 2 to 7;
C) a polyhydroxy curative;
D) an acid acceptor; and
E) an accelerator.

2. A curable composition of claim 1 wherein said fluoropolymer is crystalline.

3. A curable composition of claim 1 wherein said fluoropolymer is amorphous.

4. A curable composition of claim 3 wherein said fluoropolymer is a fluoroelastomer.

5. A curable composition of claim 4 wherein said fluoroelastomer is selected from the group consisting of copolymers of i) vinylidene fluoride with hexafluoropropylene and, optionally, tetrafluoroethylene; ii) vinylidene fluoride with a perfluoro(methyl vinyl ether), 2-hydropentafluoroethylene and optionally, tetrafluoroethylene; iii) tetrafluoroethylene with propylene and 3,3,3-trifluoropropene; iv) tetrafluoroethylene, perfluoro(methyl vinyl ether) and hexafluoro-2-(pentafluorophenoxy)-1-(trifluorovinyloxy) propane, and v) ethylene with tetrafluoroethylene, perfluoro(methyl vinyl ether) and 3,3,3-trifluoropropylene.

6. A curable composition of claim 1 wherein said β-fluoroalcohol is selected from the group consisting of 2,2,3,3-tetrafluoro-1-propanol; 2,2,3,3,3-pentafluoro-1-propanol; 1H,1H,5H octafluoro-1-pentanol; 1H,1H,7H dodecafluoro-1-heptanol; and 3-methoxy-2,2,3,3-tetrafluoro-1-propanol.

7. A curable composition of claim 1 wherein said polyhydroxy curative is selected from the group consisting of i) dihydroxy-, trihydroxy-, and tetrahydroxy-benzenes, -naphthalenes, and -anthracenes;
ii) bisphenols of the formula 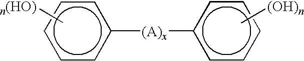
where A is a stable divalent radical; x is 0 or 1; and n is 1 or 2;
iii) dialkali salts of said bisphenols, iv) quaternary ammonium and phosphonium salts of said bisphenols, v) tertiary sulfonium salts of said bisphenols, and vi) esters of phenols.

8. A curable composition of claim 1 wherein said accelerator is selected from the group consisting of quaternary ammonium salts, tertiary sulfonium salts and quaternary phosphonium salts.

9. A curable composition of claim 1 wherein said acid acceptor is selected from the group consisting of calcium oxide, magnesium oxide and mixtures thereof.

10. A method for producing a shaped, cured article comprising the steps:
A) providing a curable composition comprising
i) a polyhydroxy curable fluoropolymer;
ii) 1 to 50 parts by weight per 100 parts by weight fluoropolymer of a β-fluoroalcohol having the formula R—(CF₂)ₙ—CH₂—OH wherein R is H, F or CH₃O, and n is an integer from 2 to 7;
iii) a polyhydroxy curative;
iv) an acid acceptor; and
v) an accelerator;
B) shaping said curable composition to form a curable shaped article; and
C) heating said curable shaped article to a temperature of at least 100° C. to cure said shaped article.

11. A method of claim 10 wherein said steps B) and C) occur in sequence.

12. A method of claim 10 wherein said steps B) and C) occur simultaneously.

13. A method of claim 10 wherein said fluoropolymer is crystalline.

14. A method of claim 10 wherein said fluoropolymer is amorphous.

15. A method of claim 14 wherein said fluoropolymer is a fluoroelastomer.

16. A method of claim 15 wherein said fluoroelastomer is selected from the group consisting of copolymers of i) vinylidene fluoride with hexafluoropropylene and, optionally, tetrafluoroethylene; ii) vinylidene fluoride with a perfluoro(methyl vinyl ether), 2-hydropentafluoroethylene and optionally, tetrafluoroethylene; iii) tetrafluoroethylene with propylene and 3,3,3-trifluoropropene; iv) tetrafluoroethylene, perfluoro(methyl vinyl ether) and hexafluoro-2-(pentafluorophenoxy)-1-(trifluorovinyloxy) propane, and v) ethylene with tetrafluoroethylene, perfluoro(methyl vinyl ether) and 3,3,3-trifluoropropylene.

17. A method of claim 10 wherein said β-fluoroalcohol is selected from the group consisting of 2,2,3,3-tetrafluoro-1-propanol; 2,3,3,3-pentafluoro-1-propanol; 1H,1H,5H octafluoro-1-pentanol; 1H,1H,7H dodecafluoro-1-heptanol; and 3-methoxy-2,2,3,3-tetrafluoro-1-propanol.

18. A method of claim 10 wherein said polyhydroxy curative is selected from the group consisting of i) dihydroxy-, trihydroxy-, and tetrahydroxy-benzenes, -naphthalenes, and -anthracenes;
ii) bisphenols of the formula 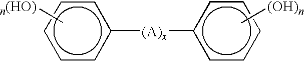
where A is a stable divalent radical; x is 0 or 1; and n is 1 or 2;
iii) dialkali salts of said bisphenols, iv) quaternary ammonium and phosphonium salts of said bisphenols, v) tertiary sulfonium salts of said bisphenols, and vi) esters of phenols.

19. A method of claim 10 wherein said accelerator is selected from the group consisting of quaternary ammonium salts, tertiary sulfonium salts and quaternary phosphonium salts.

20. A method of claim 10 wherein said acid acceptor is selected from the group consisting of calcium oxide, magnesium oxide and mixtures thereof.
